(19) United States
(12) Patent Application Publication
(10) Pub. No.: US 2011/0157493 A1
(43) Pub. Date: Jun. 30, 2011

(54) SYSTEM AND METHOD FOR ADJUSTING TELEVISION SETTINGS BASED ON MOUNTING SCHEME

(75) Inventors: Chad Andrew Lefevre, Indianapolis, IN (US); James Duane Tenbarge, Fishers, IN (US)

(73) Assignee: SHENZHEN TCL NEW TECHNOLOGY LTD., Shekou, Shenzhen, Guangdong (CN)

(21) Appl. No.: 13/060,069

(22) PCT Filed: Nov. 24, 2008
(86) PCT No.: PCT/US08/84570

§ 371 Date: Feb. 22, 2011

(30) Foreign Application Priority Data
Sep. 4, 2008 (CN) 200810212237.0

(51) Int. Cl. H04N 5/655

(52) U.S. Cl. 348/836; 348/E05.132

(57) ABSTRACT

There is provided a system and method for adjusting television settings based on a detected or input mounting scheme of the television. More specifically, in one embodiment, there is provided a method, comprising determining an active mounting scheme for a television, employing a first group of settings if the active mounting scheme for the television corresponds to a first mounting scheme, and employing a second group of settings if the active mounting scheme for the television corresponds to a second mounting scheme.

### FIELD OF THE INVENTION

The present invention relates generally to a system and method for adjusting television settings and, more specifically, to determining a certain characteristics relating to the environment of the television and adjusting television settings accordingly.

### BACKGROUND OF THE INVENTION

This section is intended to introduce the reader to various aspects of art, which may be related to various aspects of embodiments of the present invention that are described and/or claimed below. This discussion is believed to be helpful in providing the reader with background information to facilitate a better understanding of the various aspects of embodiments of the present invention. Accordingly, it should be understood that these statements are to be read in this light, and not as admissions of prior art.

A television (i.e., TV) may be described as a telecommunication system for displaying moving pictures and transmitting sound based on program data received from a provider. Watching television is currently very popular, and the television has become a common household and business communications device. Indeed, televisions are frequently used is businesses (e.g., sports bars) and homes. As televisions are now available in relatively thin packages, televisions may be positioned in a greater number of locations and orientations than in the past. For example, a television may be positioned on a stand in the middle of a room, set atop a pedestal, positioned within a cabinet, or mounted on a wall to facilitate viewing. Different viewing settings may produce better viewing results, depending on the location and orientation of a particular television.

### BRIEF DESCRIPTION OF THE DRAWINGS

Advantages of embodiments of the present invention may become apparent upon reading the following detailed description and upon reference to the drawings in which:

FIG. 1 is a block diagram of an electronic device in accordance with an exemplary embodiment of the present invention; and

FIG. 2 is a process flow diagram representing a process for television setting adjustment in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

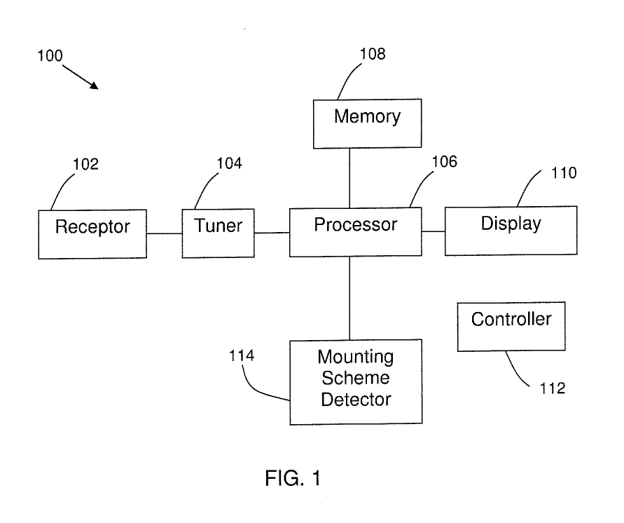

FIG. 1 is a block diagram of an electronic device in accordance with an exemplary embodiment of the present invention. The electronic device 100, which comprises a television in the exemplary embodiment shown in FIG. 1, is generally indicated by reference numeral 100. The television 100 comprises a receptor 102 (e.g., a cable inlet or an antenna), a tuner 104, a processor 106, a memory 108, a display 110, a controller 112 (e.g., remote control), and a mounting scheme detector 114. In some exemplary embodiments, the television 100 may be a flat panel television, so named because the display 110 is a flat panel display. A flat panel television may be positioned in a wide range of locations and orientations. For example, a flat panel television may be mounted in a cabinet in a user's living room or mounted on a wall in a business, to name just two examples.

The memory 108 of the electronic device 100 may be adapted to hold machine-readable computer code that causes the processor 106 to perform an exemplary method in accordance with embodiments of the present invention. For example, in one exemplary embodiment, the memory 108 may store machine-readable computer code that instructs the processor 106 to change certain settings of the television 100 based on input received via the mounting scheme detector 114. In one exemplary embodiment, the mounting scheme detector 114 comprises a sensor that is configured to detect a mounting scheme of the electronic device. In another embodiment, the mounting scheme detector 114 may simply represent an input mechanism, such as a button on the controller 112. The processor 106 or the memory 108 may include a settings module configured to employ a first group of settings if the active mounting scheme for the television corresponds to a first mounting scheme and employ a second group of settings if the active mounting scheme for the television corresponds to a second mounting scheme.

Traditionally, televisions are manufactured such that some settings are modifiable by a user and some settings are not modifiable by the user. For example, audio settings such as bass and treble values, equalizer settings, and so forth may be set in the television's software such that they are only slightly modifiable by a user while a volume taper setting may be set such that it is not modifiable by the user. Indeed, traditional televisions generally have predefined audio settings for volume taper, audio equalizer presets (e.g., presets for standard use, gaming, movies, voice, and music), volume ratios for integrated directional speakers, surround sound proportions, and so forth that are not adjustable by the user.

It is now recognized that it may be desirable to change certain display and/or audio settings for a television based on the arrangement of the television with respect to its surroundings. The predefined television settings discussed above may not take into account the mounting scheme of the television. Depending on the mounting scheme, different settings may be desirable. Indeed, the same settings for a television mounted on a wall may have a different result when the television is mounted on a stand. For example, because the speakers may be directly adjacent the wall when the television is wall mounted, echo effects and so forth may make different audio settings desirable compared to when the television is mounted on a stand away from any walls. Accordingly, embodiments of the present invention may include a feature that facilitates adjustment of the settings based on the mounting scheme of the television 100. It should be noted that wall mounting may include positioning the television directly adjacent a solid structure (e.g., a wall of a room or a wall of a cabinet).

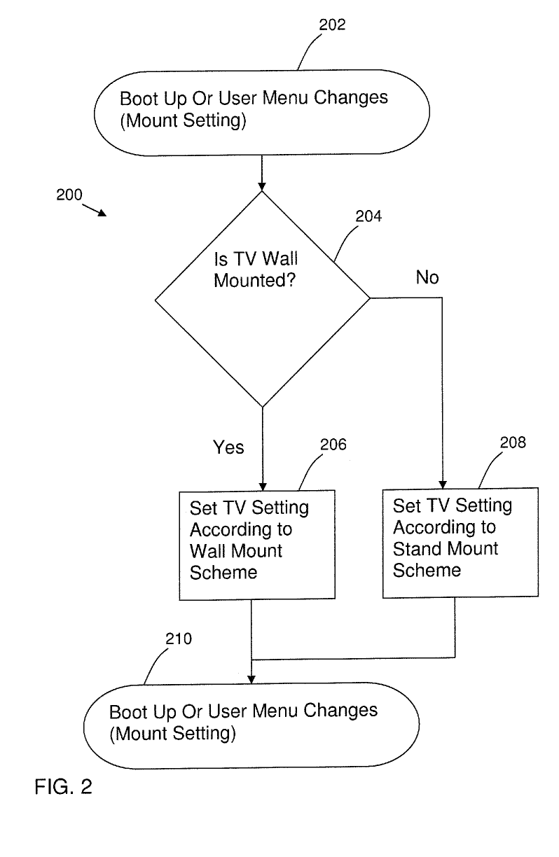

FIG. 2 is a process flow diagram representing a process for television setting adjustment in accordance with an exemplary embodiment of the present invention. The process is generally indicated by reference numeral 200. The illustrated embodiment of the process 200 begins with booting the television 100 or changing a setting (e.g., changing a mounting scheme), as represented by block 202. Once the television 100 is booted or the setting is changed, a determination is made as to whether the television 100 is mounted on a wall or on a stand, as illustrated by block 204. Detecting the mounting scheme may include input from a user-menu option or may include input from a sensor. In one embodiment, the mounting scheme detector 114 may include a control feature that a user may simply select or activate to indicate that the television 100 is mounted on a wall. In another embodiment, the mounting scheme detector 114 may include a sensor that dynamically detects an indicator of whether the television is mounted on a wall. For example, the sensor may detect a mounting bracket via a mechanical switch, an electrical connection, or the like to determine the mounting scheme of the television 100. In another example, the sensor may detect a distance of the television 100 from a structure.

If a determination is made that the television is mounted on a wall, corresponding settings for a wall mount scheme are implemented, as illustrated in block 206. If a determination is made that the television is not mounted on a wall, corresponding settings for a stand mount scheme are implemented, as illustrated in block 208. Block 210 represents operation of the television 100 with the applied settings.

Regarding the change in settings based on the detected mounting scheme, various different settings may be changed in accordance with present embodiments. For example, audio settings may be changed and other settings may be changed to be in a range more suitable for the detected settings. Additionally, the availability of certain options may be contingent upon which mounting scheme is detected. By allowing such settings and options to be adjusted and/or optionally provided, a user is enabled to change the mounting scheme of the television and have properly adjusted settings rather than being limited by the preprogrammed settings.

While embodiments of the invention may be susceptible to various modifications and alternative forms, specific embodiments have been shown by way of example in the drawings and will be described in detail herein. However, it should be understood that the embodiments of the invention are not intended to be limited to the particular forms disclosed. Rather, the embodiments of the invention are to cover all modifications, equivalents and alternatives falling within the spirit and scope of the embodiments of the invention as defined by the following appended claims.

What is claimed is:

1. A method, comprising:
determining an active mounting scheme for a television;
employing a first group of settings if the active mounting scheme for the television corresponds to a first mounting scheme; and
employing a second group of settings if the active mounting scheme for the television corresponds to a second mounting scheme.

2. The method of claim 1, wherein determining the active mounting scheme comprises receiving input from a sensor.

3. The method of claim 2, wherein receiving input from the sensor comprises receiving input regarding an arrangement of a mounting bracket with respect to the television.

4. The method of claim 1, wherein determining the active mounting scheme comprise dynamically detecting the active mounting scheme during booting of the television.

5. The method of claim 1, wherein determining the active mounting scheme comprises receiving input from a user-activated controller.

6. The method of claim 1, comprising defining the first group of settings corresponding to the first mounting scheme and the second group of settings corresponding to the second mounting scheme.

7. The method of claim 6, wherein defining the first group of settings corresponding to the first mounting scheme comprises defining audio settings corresponding to a wall mounted scheme.

8. The method of claim 6, wherein defining the second group of settings corresponding to the second mounting scheme comprises defining audio settings corresponding to a stand mounted scheme.

9. The method of claim 1, wherein determining the active mounting scheme comprise detecting the active mounting scheme during operation of the television after a menu change.

10. The method of claim 1, comprising making an option available for configuration of the television based on whether the active mounting scheme corresponds to the first mounting scheme.

11. A system, comprising:
a television;
a mounting scheme detector configured to determine an active mounting scheme for the television; and
a settings module configured to employ a first group of settings if the active mounting scheme for the television corresponds to a first mounting scheme and employ a second group of settings if the active mounting scheme for the television corresponds to a second mounting scheme.

12. The system of claim 11, wherein the mounting scheme detector comprises a sensor.

13. The system of claim 12, wherein the sensor is configured to detect an arrangement of a mounting bracket with respect to the television, wherein the arrangement is indicative of the active mounting scheme.

14. The system of claim 11, wherein the sensor is configured to detect a distance between a back of the television and a solid structure.

15. The system of claim 11, wherein the first group of settings comprises audio settings.

16. The system of claim 11, wherein the mounting scheme detector is configured to dynamically detect the active mounting scheme during booting of the television.

17. The system of claim 11, wherein the mounting scheme detector is configured to receive input from a user-activated controller.

18. The system of claim 11, comprising a memory storing the first group of settings corresponding to the first mounting scheme and the second group of settings corresponding to the second mounting scheme.

19. The system of claim 11, wherein the television comprises a flat panel display.

20. A system, comprising:
means for determining an active mounting scheme for a television;
means for employing a first group of settings if the active mounting scheme for the television corresponds to a first mounting scheme; and
means for employing a second group of settings if the active mounting scheme for the television corresponds to a second mounting scheme.
